(19) United States
(12) Patent Application Publication
(10) Pub. No.: US 2008/0137182 A1
(43) Pub. Date: Jun. 12, 2008

(54) MODULATION OF COVERT AIRFIELD LIGHTING FIXTURES

(75) Inventors: Daniel A. That, South Windsor, CT (US); James M. Mitsch, Simsbury, CT (US)

Correspondence Address: KING & SPALDING, LLP, 1100 LOUISIANA ST., STE. 4000, ATTN.: IP Docketing, HOUSTON, TX, 77002-5213, US

(73) Assignee: Cooper Technologies Company, Houston, TX (US)

(21) Appl. No.: 11/567,992

(22) Filed: Dec. 7, 2006

(51) Int. Cl. G02B 13/14

(52) U.S. Cl. 359/350

(57) ABSTRACT

Airfield lighting fixtures, systems, and methods are described, including covert lighting fixtures, systems, and methods.

### BACKGROUND

The present disclosure relates in general to airfield lighting systems and methods and in particular to covert airfield lighting systems and methods.

### BRIEF DESCRIPTION OF THE DRAWINGS

FIG. 1 is a diagram of an airfield, showing different features that can be marked using a covert lighting system embodiment;

FIG. 2 shows intensity vs. time plots for several possible modulation modes useful in embodiments;

FIG. 3 shows intensity vs. time plots for a phased modulation scheme useful in embodiments;

FIG. 4 contains a block diagram for a covert airfield lighting fixture according to one embodiment;

FIG. 5 illustrates intensity vs. time plots for on/off modulation to approximate a linear intensity modulation effect;

FIG. 6 contains a block diagram for a dual-mode covert/visible lighting fixture according to one embodiment;

FIGS. 7 and 8 depict, respectively, an elevated lighting form factor and an in-ground form factor for dual-mode covert/visible lighting fixtures;

FIG. 9 shows, for a stylized airfield section, one exemplary covert lighting modulation scheme;

FIG. 10 shows, for the airfield section of FIG. 9, corresponding visible lighting for the airfield features marked in FIG. 9;

FIG. 11 shows an elevated lighting form factor for dual-mode covert/visible lighting fixtures;

FIG. 12 contains a block diagram for a covert airfield lighting fixture according to one embodiment; and

FIG. 13 contains a block diagram for a covert airfield lighting fixture according to one embodiment.

### DETAILED DESCRIPTION OF THE ILLUSTRATIVE EMBODIMENTS

Airfield lighting systems are generally used to aid pilots during aircraft takeoff, landing, and taxiing in times of darkness and/or poor visibility. Although airfield lighting systems differ in capability and complexity, the visual components of such systems are standardized to offer familiarity to pilots landing at unfamiliar airports. Generally, different light colors or color combinations are used to indicate different airport features.

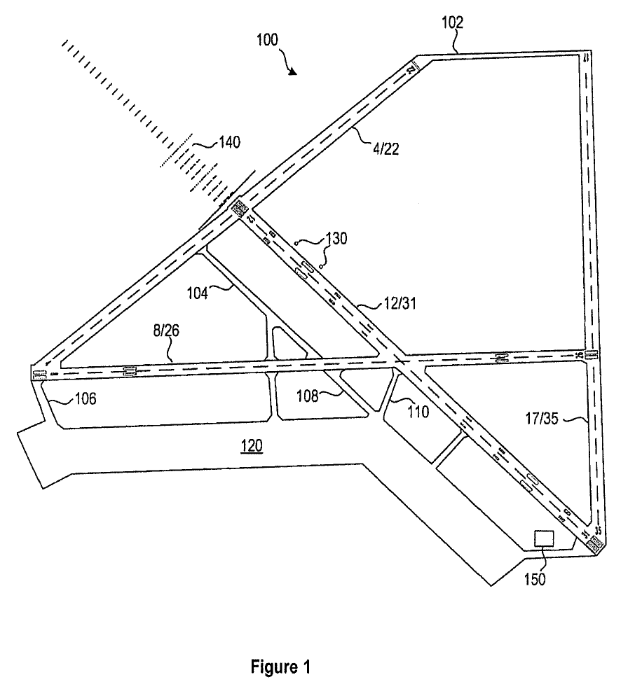

FIG. 1 illustrates an exemplary airport layout 100 with four main runways (4/22, 8/26, 12/31, and 17/35), various taxiways (e.g., 102, 104, 106, 108, and 110), and an apron 120. Each of these features can be lighted. Each runway intended for nighttime operation is equipped with runway edge lights, which are white. On instrument runways the last 2,000 feet of the runway is equipped with yellow lights as a cautionary aid. At the ends of each runway, runway end lights emit red light toward the runway and green light away from the runway. Some precision approach runways also contain in-ground centerline lighting, which are white until the last 3,000 feet of the runway, alternate with red for the next 2,000 feet of the runway, and red for the last 1,000 feet of the runway. Taxiway leadoff lights may extend from the runway centerline to a centerline point on an exit taxiway (e.g., 108, 110) to aid aircraft exiting the runway. Taxiways themselves and the edges of apron 120 that face the runway/taxiway area are identified by blue edge lights. The centerlines of taxiways, turns between taxiways, and designated taxiing paths in portions of runways and aprons are illuminated with green light. Clearance bar and runway guard lights are yellow, and are installed across taxiways at intersections with runways or other taxiways. Red stop bar lights are installed across a taxiway at a runway hold position.

Other airfield lights help the pilots of incoming aircraft identify, and align with, the active runway. These include visual glideslope indicators 130, which help the pilot maintain a proper descent trajectory to the touchdown zone, while providing sufficient clearance above off-runway obstacles. One common glideslope indicator 130 is a PAPI (Precision Approach Path Indicator) that emits steady white or red light near or on the intended glide path, and pulses the light further above and below the glide path. Also, various Approach Lighting System (ALS) configurations (e.g., 140) can be deployed in the approach area just beyond the runway threshold. Depending on configuration, an ALS may consist of tracks and bars of red and white lights, and may include sequenced flashing lights that appear as a white light traveling rapidly across the ground towards the active runway threshold twice a second.

During military or commercial aircraft operations in or near potentially hostile areas, aircraft are vulnerable to attack from unsophisticated weapons while they approach or depart airports at relatively low altitude and speed, and while they taxi around an airfield on the ground. Conducting such operations at night, without visible aircraft marker lights, can reduce the risk of a successful attack from beyond the airfield perimeter. Unfortunately, the various airfield lights used to aid takeoff, landing, and taxiing can also provide significant light for a hostile party to locate an otherwise darkened aircraft on the airfield, either due to reflection or shadowing. Also, these lights provide cues to one who seeks to attack critical areas of the airport itself, such as runways, approach and glideslope lighting, etc., at night.

In embodiments described herein, airfield lighting fixtures are provided that operate in covert lighting modes, e.g., using infrared rather than visible light. Pilots equipped with infrared night vision goggles or similar aids can identify the airfield markers and navigational cues on, e.g., airfield 100, while hostile entities without infrared equipment see only a darkened field. This reduces the risk of a successful nighttime attack from an unsophisticated enemy.

It has now been recognized that several difficulties in deploying a covert lighting system with different marker types on an airfield such as airfield 100 exist, due to the nature of infrared night vision equipment. Such equipment is generally monochromatic—it detects infrared radiation in a range of wavelengths (which may be narrow or broad) without distinguishing between various wavelengths or “colors”, and displays this information monochromatically (or colored to represent intensity, not wavelength) to a human observer. Also, such equipment generally contains detector array gain control circuitry that would tend to saturate the infrared detector response at small, bright locations such as those represented by airfield markers in order to provide fine heat detail in the broad areas of the image, making marker intensity a difficult marker discriminator. Finally, apparent intensity varies with range, making intensity even more difficult as a marker discriminator for an aircraft closing on an airfield.

Several embodiments will now be described that can provide a covert airfield lighting system on an airfield such as airfield 100 that can benefit from multiple marker types. In general, these systems employ airfield lighting fixtures capable of modulating a covert light source according to a defined modulation mode. One or more control units 150 instruct covert airfield lighting fixtures deployed in and around the runways and taxiways to activate according to a modulation scheme. In this scheme, different modulation modes are employed for different airfield marker types. Thus even when used with infrared night vision equipment that has no wavelength discrimination and little or no intensity discrimination for bright sources, the covert lighting system allows a pilot to discriminate airfield features and conduct covert airfield operations.

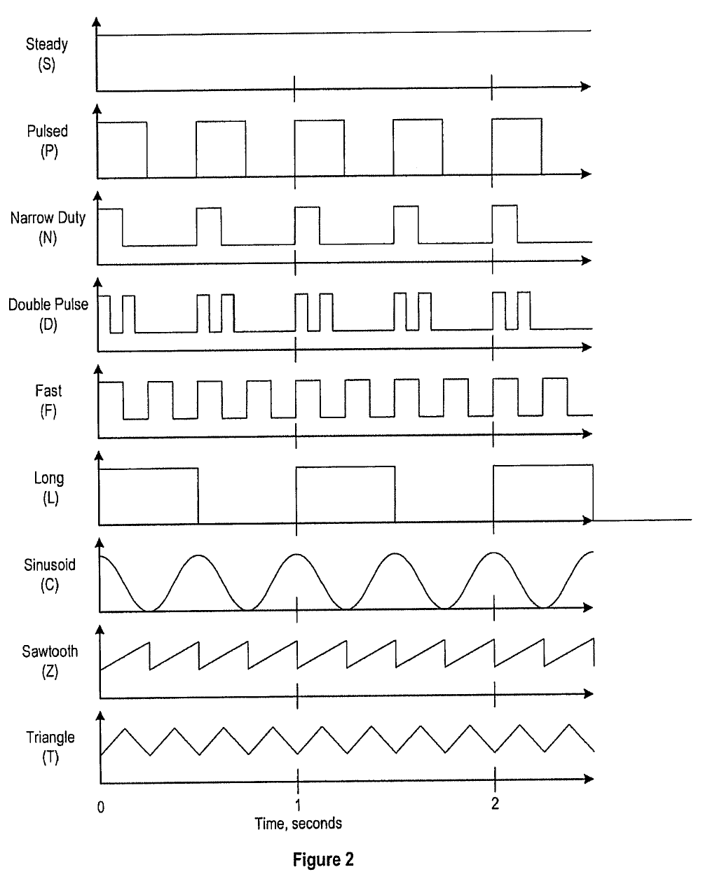

FIG. 2 shows several exemplary apparent modulation modes that can be employed with the covert lighting fixtures. As will be described, a different actual modulation mode may or may not be used to generate each of these apparent modes, but these represent the intensity modulation that a human observer would believe that she sees when viewing the airfield through night vision/IR equipment. Examining FIG. 2 from top to bottom, the first illustrated mode is a steady (S) mode that approximates a constant intensity. Different steady intensities can be approximated, but may not be distinguishable from each other by a pilot.

The second through fifth modes shown in FIG. 2 are all pulsed modes that illustrate different combinations of modulation parameters. The basic pulsed (P) mode shown is an on/off, 50% duty cycle mode with two pulses/second. The narrow duty mode (N) has the same pulse repetition rate, but only a 25% duty cycle (125 ms pulse), and can be distinguished from the P mode due to its briefer flashes. Note also that the narrow duty mode is illustrated with a 75% modulation depth, i.e., in the “off” portions of the pulse cycle the apparent intensity is reduced by 75% instead of 100% as shown for the pulsed P mode. The double pulse (D) mode replaces the single pulses of the P and N modes with two 12.5% duty cycle (62.5 ms) pulses separated by a 62.5 ms off pulse. The fast pulse (F) mode uses a pulse repetition rate of four pulses/second, with 125 ms pulses at a 50% duty cycle. The long pulse (L) mode uses a one pulse/second pulse repetition rate, with a 500 ms pulse at 50% duty cycle. Other similar pulsed modes can be specified, e.g., by varying modulation parameters for pulse repetition rate, duty cycle, multiple pulse number, and modulation depth.

Other distinguishable modulation modes can be based on changing the apparent shape of the infrared pulses from simple on/off pulsing to other shapes. FIG. 2 illustrates three such exemplary modes, with sinusoid (C), sawtooth (Z), and triangle (T) waveshapes. The sinusoid waveshape takes the appearance, to a stationary observer, of a distant rotating light source. The sawtooth waveshape ramps to a maximum intensity, drops rapidly, and repeats (a reverse sawtooth is also possible but not shown). The triangle waveshape is a variation of the sawtooth waveshape with both up and down ramps. Each of these various shapes can be further modified by specifying on or off plateaus, different rise/fall times or frequencies, different modulation depths, and maximum intensities.

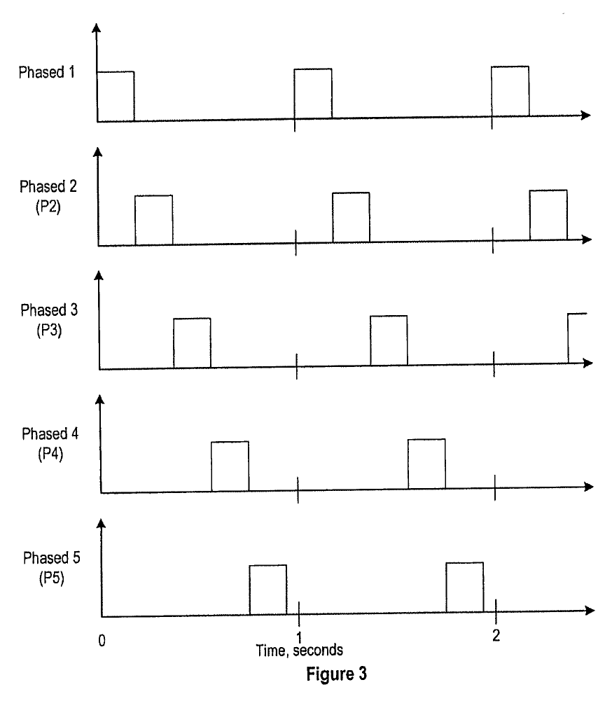

In at least some embodiments, the various periodic modulation modes selected for different airfield marker types are multiples of a basic period, with the various airfield markers timed to coordinate the pulses so that the different pulse types maintain a set synchronization to each other. For instance, the various pulses shown in FIG. 2 are designed such that the same overall airfield pulse pattern is repeated every second. FIG. 3 illustrates another modulation parameter, phase, that can be used in this synchronized framework to create another visual effect. FIG. 3 shows five phased modulation modes, P1 to P5. P1 pulses on then off, followed by P2, P3, etc. The pulses can be designed to overlap in time, or have different gaps, by varying phase (or delay) and duty cycle. These parameters can also be used to accommodate a greater or smaller number of markers in a phased group within a given repetition period. When the phased modulation modes are applied to a group of markers, the effect is that of a light moving between the markers.

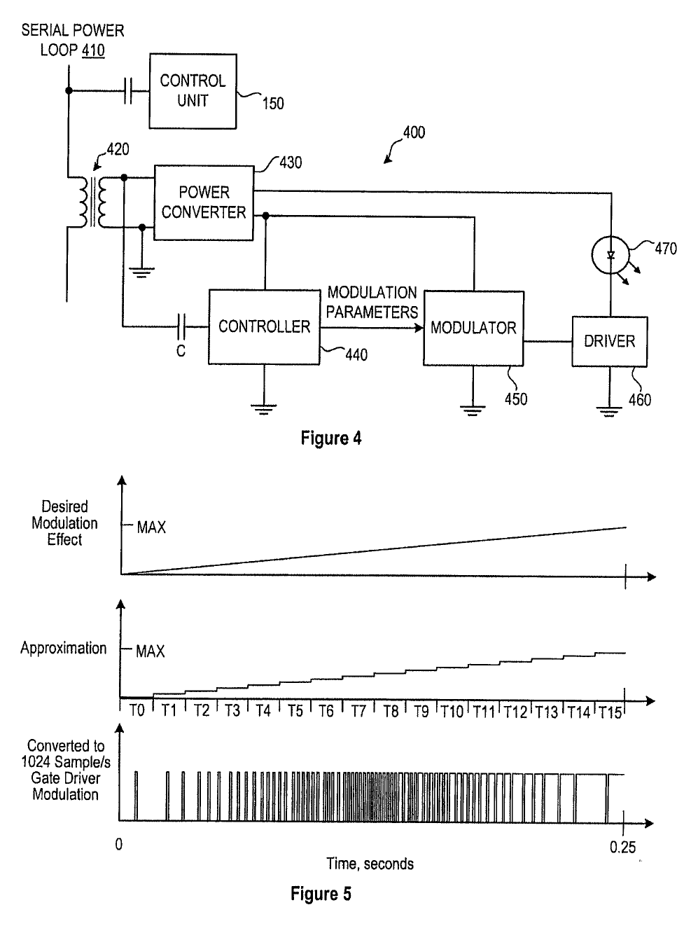

FIG. 4 illustrates the basic electronic configuration of a covert airfield lighting fixture 400 according to one embodiment. The supply side of a transformer 420 connects to a serial power loop 410 that also supplies AC power to other lighting fixtures (not shown) in a common group, as is known in the art. The other side of transformer 420 connects to a power converter 430 that rectifies the input power to provide DC power to other components of fixture 400.

A controller 440 sets the modulation mode for lighting fixture 400. In FIG. 4, controller 440 couples through a capacitor C (or other suitable highpass filter) to the output side of transformer 420. A control unit 150 (see, e.g., FIG. 1) remote from the lighting fixtures also attaches to serial power loop 410. Control unit 150 transmits instructions to controller 440, over serial power loop 410, at a transmit frequency significantly higher than the power supply frequency. This allows controller 440 to separate the control signals from the AC power signal also transmitted on the serial power loop. The instructions signal to the controller when to activate the covert light source, the proper source timing, and the desired modulation mode.

When the covert light source is activated, controller 440 supplies modulation parameters, such as those described in conjunction with FIGS. 2 and 3, to a modulator 450. Modulator 450 uses the modulation parameters to generate a modulation signal to a driver 460, which in turn controls a covert light source 470. In one embodiment, covert light source 470 comprises one or more infrared light-emitting diodes (LEDs) controlled, for example, using electronics or driving the LEDs directly from a power source.

On/off modulation can be applied directly at the visible pulse frequency for simple modulation modes that shift the covert light source between maximum intensity and off, such as the P mode shown in FIG. 2. For modulation modes requiring a non-zero intensity less than maximum intensity during all or part of a pulse repetition cycle, and/or for modes that involve creating a graded pulse shape (such as triangular ramps and sinusoidal pulses), a different modulation technique is used. FIG. 5 illustrates this technique.

In FIG. 5, the desired modulation effect is a linear ramp from 0 to full intensity (MAX) over a quarter second. This effect is approximated by quantizing the desired modulation effect at a number of discrete intervals T0, T1, T2, etc. The approximation of the desired linear ramp is illustrated with sixteen such intervals over the quarter second timeframe. At each of the sixteen intervals, sixteen subintervals are available for modulation of the covert light source. Modulator 450 selects a number of subintervals in each interval during which it will activate driver 460, according to the quantized value of the desired modulation effect. For instance, if driver 460 is activated during four subintervals of an interval (such as interval T3), the covert light source will appear to be illuminated at ¼ MAX intensity over that interval. As another example, during interval T12 driver 460 is activated for twelve of the sixteen subintervals, making the covert light source appear to be illuminated at ¾ MAX intensity over that interval.

Once modulator 460 selects the number of subintervals that it will activate driver 460, it selects an appropriate on/off modulation signal sequence. In one embodiment, the on and off subintervals are evenly distributed, as much as possible, over the interval, as shown in the 1024 Hz modulation pulse conversion gate drive signal of FIG. 5.

From the FIG. 5 illustration, it can be appreciated how various waveforms can be quantized and converted to a pulse train that achieves different visual modulation effects. Because the pulse modulation occurs at frequencies well above those detectable by the human visual system, the appearance of different constant intensities and relatively slowly modulated intensities is readily achieved.

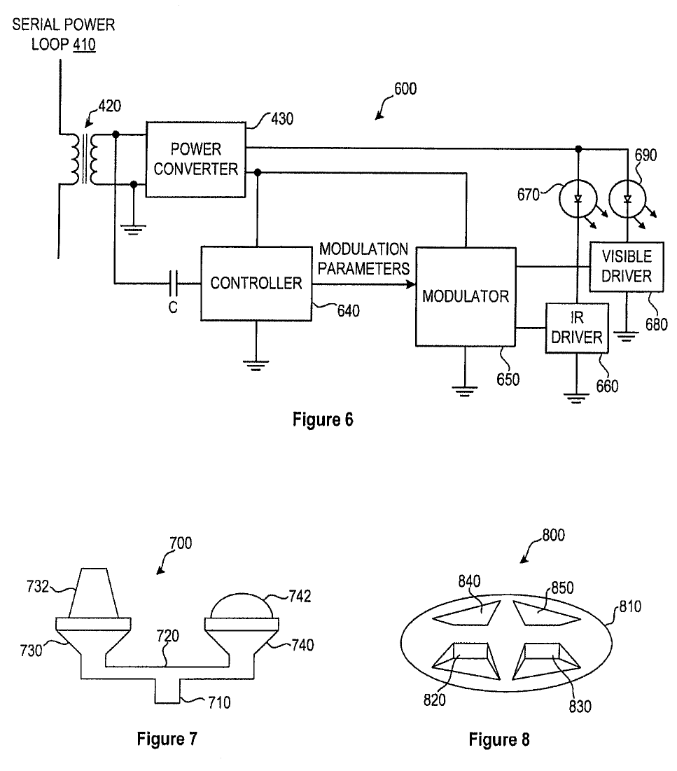

FIG. 6 illustrates an airfield lighting fixture block diagram 600 that is operable in both covert and non-covert lighting modes. A controller 640 operates like controller 440 of FIG. 4, but also accepts instructions that select either a covert or non-covert lighting mode. Depending on the selected mode, controller 640 will instruct a modulator 650 to illuminate either an infrared LED 670 or a visible LED 690. Modulator 650 is equipped to drive two drivers, an IR driver 660 for infrared LED 670 and a visible driver 680 for visible LED 690. Each driver is modulated as described above for driver 460, in its appropriate mode.

The physical configuration of a dual-mode covert/non-covert lighting fixture is exemplified by an edge lighting fixture 700 (FIG. 7) and an in-ground fixture 800 (FIG. 8). Edge fixture 700 comprises a post 710 supporting a crossbar 720, which in turn supports a visible light source housing 730 and a covert light source housing 740. The visible light source housing supports the visible light source, visible through an appropriately colored dome 732. Likewise, the covert light source housing 740 supports the covert light source, visible through an IR-transparent dome 742. The electronics described in FIG. 6 can be housed in the post/housing structure and/or in a separate enclosure mounted, e.g., above ground or underground near the post structure.

The above-ground appearance of in-ground fixture 800 is illustrated in FIG. 8. Housing 810 is designed to be mounted semi-flush with a runway or taxiway surface, and has sufficient structural strength to support an aircraft rolling over the fixture. Indentations in housing 810 lead to two recessed windows 820 and 830 that are aligned with the surface to face inbound traffic. Window 820 covers a visible light source, and is appropriately colored for the fixture location on the airfield. Window 830 covers a covert light source, and is IR transparent. When the in-ground fixture 800 is desired to be visible from opposite directions, a second set of recesses 840, 850 lead to a second set of visible and IR windows (not visible in FIG. 8).

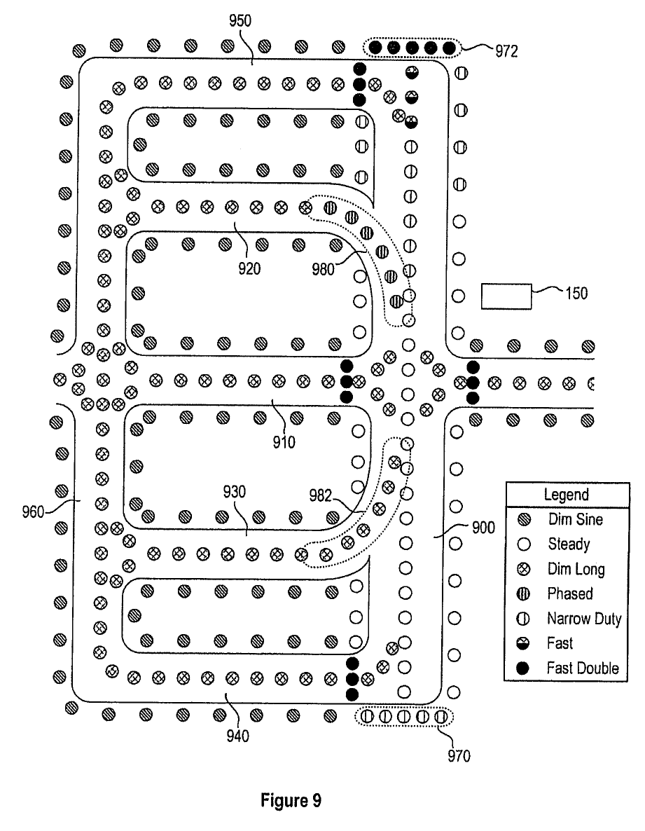

FIG. 9 illustrates one possible deployment of covert lighting fixtures on a stylized airfield section comprising a runway 900, a crossing taxiway 910, two high-speed taxiways 920, 930, two departure taxiways 940, 950, and a parallel taxiway 960. Assuming traffic departs and arrives from the end of runway 900 adjoining departure taxiway 940, one exemplary covert light fixture modulation scheme is illustrated. The runway edge lights are modulated to appear at a steady intensity, except for the last 2000 feet of the runway, which are modulated to display a narrow-duty pulsetrain (see FIG. 2). Likewise, the runway centerline lights are modulated at a steady intensity, except the last 1000 feet are modulated as a fast pulsetrain, and the 2000 feet immediately preceding that are modulated as a fast pulsetrain. The threshold lights 970 are modulated with a narrow-duty pulse and the runway end lights 972 are modulated with a fast double pulsetrain. In an embodiment, all modulation modes of like fixtures are synchronized with each other such that differently modulated light groups do not drift in and out of phase with each other.

Generally, lights may be modulated with a square wave form and the frequency may differ between different type fixtures to allow the different type fixtures to be distinguished from one another.

In one embodiment, an airfield lighting control unit 150 is capable of instructing various light groups to change modulation modes. When traffic is reversed to land the opposite direction on runway 900, runway lead-off lights 980 are modulated as taxiway centerline lights, and runway lead-off lights 982 are modulated with a phased pulsetrain. The modulation schemes of runway end lighting 970 and 972 are likewise reversed, and the modulation of the runway edge lights and centerline lights is modified to indicate the appropriate distances to the opposite end of the runway. Note that not all airfield configurations need have so many different kinds of lights or the capability to change modes remotely. Likewise, some airfield configurations may have even greater capabilities than those shown.

The intensity ratios of each modulation mode can be adjusted based on experimental data and pilot preference. Once the intensity ratios are set, the overall intensity of the entire airfield configuration can be raised and lowered as requested by a pilot or air traffic controller, with each modulation mode adjusting appropriately. Control units 150 transmits the new intensity instruction to all lighting fixtures, which adjust their modulation modes accordingly.

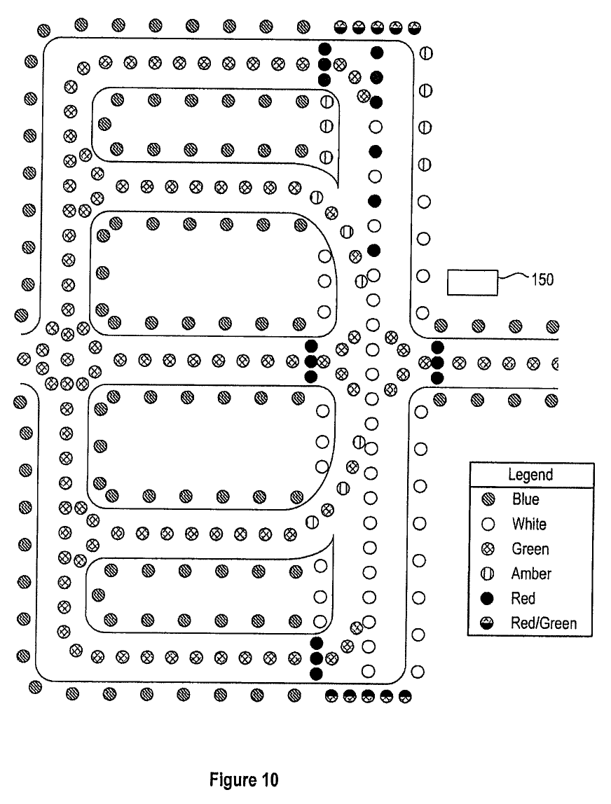

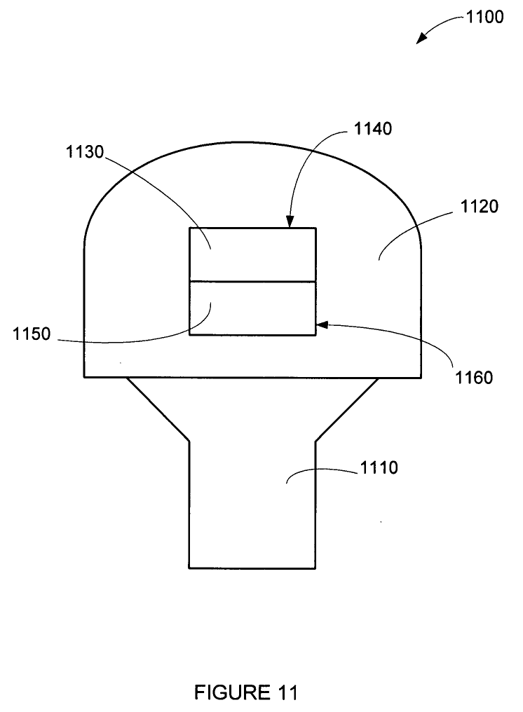

When the airfield lighting fixtures are capable of operation in a non-covert mode, FIG. 10 shows the visible, steady-burning colors emitted by each fixture in the non-covert mode.

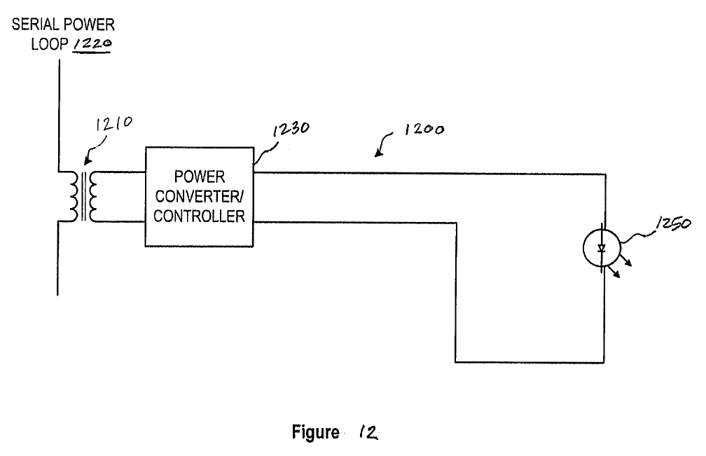

In an alternative embodiment, the physical configuration of a dual-mode covert/non-covert lighting fixture is exemplified by an edge lighting fixture 1100 (FIG. 11). Edge fixture 1100 comprises a post 1110 supporting a visible light source and covert light source housing 1120. The visible light source and covert light source housing 1120 supports a visible light source 1130, visible through an appropriately colored dome portion 1140. The visible light source and covert light source housing 1120 also supports a covert light source 1150, visible through an IR-transparent dome portion 1160. The electronics described in FIG. 6 can be housed in the post/housing structure and/or in a separate enclosure mounted, e.g., above ground or underground near the post structure.

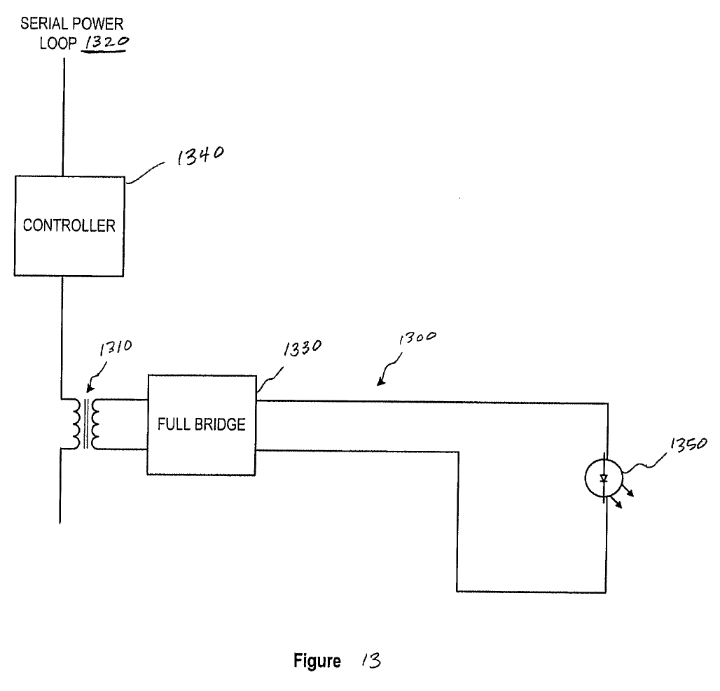

FIG. 12 illustrates the basic electronic configuration of a covert airfield lighting fixture 1200 according to one embodiment. The supply side of a transformer 1210 connects to a serial power loop 1220 that also supplies AC power to other lighting fixtures (not shown) in a common group, as is known in the art. The other side of transformer 1210 connects to a power converter/controller 1230 that rectifies the input power to provide DC power to other components of fixture 1200 such as, for example, a covert light source 1250.

The power converter/controller 1230 sets the modulation mode for lighting fixture 1200. In FIG. 12, a power converter/controller 1230 couples through a capacitor C (or other suitable highpass filter) to the output side of transformer 1210. The power converter/controller 1230 transmits instructions over serial power loop 410 at a transmit frequency significantly higher than the power supply frequency. This allows the power converter/controller 1230 to separate the control signals from the AC power signal also transmitted on the serial power loop. The instructions signal to the controller when to activate the covert light source, the proper source timing, and the desired modulation mode.

When the covert light source is activated, the power converter/controller 1230 supplies modulation parameters, such as those described in conjunction with FIGS. 2 and 3, to generate a modulation signal, which in turn controls a covert light source 1250. In one embodiment, covert light source 1250 comprises one or more infrared light-emitting diodes (LEDs) controlled, for example, using electronics or driving the LEDs directly from a power source.

On/off modulation can be applied directly at the visible pulse frequency for simple modulation modes that shift the covert light source between maximum intensity and off, such as the P mode shown in FIG. 2. For modulation modes requiring a non-zero intensity less than maximum intensity during all or part of a pulse repetition cycle, and/or for modes that involve creating a graded pulse shape (such as triangular ramps and sinusoidal pulses), a different modulation technique is used. FIG. 5 illustrates this technique.

FIG. 13 illustrates the basic electronic configuration of a covert airfield lighting fixture 1300 according to one embodiment. The supply side of a transformer 1310 connects to a serial power loop 1320 that also supplies AC power to other lighting fixtures (not shown) in a common group, as is known in the art. The other side of transformer 1310 connects to a full bridge 1330 that rectifies the input power to provide DC power to other components of fixture 1300.

A controller 1340 remote from the lighting fixtures also attaches to serial power loop 1320. Controller 1340 transmits instructions to light fixture 1300, over serial power loop 1320, at a transmit frequency significantly higher than the power supply frequency. This allows full bridge 1330 to separate the control signals from the AC power signal also transmitted on the serial power loop. The instructions signal to the controller when to activate the covert light source, the proper source timing, and the desired modulation mode.

When the covert light source is activated, controller 1340 supplies modulation parameters, such as those described in conjunction with FIGS. 2 and 3. The modulation parameters are used to generate a modulation signal which in turn controls a covert light source 1350. In one embodiment, covert light source 1350 comprises one or more infrared light-emitting diodes (LEDs) controlled, for example, using electronics or driving the LEDs directly from a power source.

On/off modulation can be applied directly at the visible pulse frequency for simple modulation modes that shift the covert light source between maximum intensity and off, such as the P mode shown in FIG. 2. For modulation modes requiring a non-zero intensity less than maximum intensity during all or part of a pulse repetition cycle, and/or for modes that involve creating a graded pulse shape (such as triangular ramps and sinusoidal pulses), a different modulation technique is used. FIG. 5 illustrates this technique.

Various modifications can be incorporated, singly or in combination, in the embodiments described above. The controller in each fixture may receive mode and timing instructions over an electrical or optical signal path that is separate from the power connection. Alternately, mode and timing may be communicated wirelessly, with each controller incorporating a wireless receiver. In each case, each fixture may receive instructions for a fixture group or for all fixtures, and distinguish instructions intended for itself from instructions intended for other fixtures. The fixtures may be assigned individual fixture addresses and/or fixture group addresses to facilitate such control.

In many embodiments, the controller and modulator can be implemented using a processor and attached memory. The memory can comprise flash or other non-volatile memory to hold communication and modulation programs and fixture addresses, and working memory to receive and process instructions and calculate modulation sequences.

Lighting fixtures can alternately be “hardwired” for different modulation modes, e.g., using as a controller a selection module keyed to one of several selectable modes. The selection module can, e.g., comprise flash or read-only memory describing a desired modulation mode, or a set of switches on the fixture. With a removable selection module, different selection modules can be keyed to different modulation modes, or a programming tool can be used to set the selection module to a desired mode.

Although digital pulse modulation has been described, some sources may be modulated by other techniques such as analog voltage control of the lighting source supply voltage.

Dedicated covert lighting fixtures can be deployed in form factors similar to those used for visible light fixtures, using IR-transparent windows and domes. Edge lighting fixtures can also be deployed as portable units, e.g., for use on temporary runways or temporary covert usage at an airport. Some embodiments can be battery powered in addition to or instead of powered from a power loop.

An airfield lighting system has been described that includes a modulator to generate a modulation signal, the modulation signal corresponding to one of a plurality of selectable covert lighting modulation modes, a lighting fixture controller to select one of the covert lighting modulation modes for the modulator, and a covert lighting driver operable in response to the modulation signal. In an embodiment, a covert light source is controlled by the covert lighting driver. In an embodiment, the covert light source comprises at least one infrared light-emitting diode. In an embodiment, each covert lighting modulation mode relates to one or more modulation parameters that affect the modulation signal to create the appearance to a human observer, viewing the fixture through a suitable viewing apparatus, of a designated airfield marker type. In an embodiment, the modulation parameters are adjustable to create the appearance to the human observer of intensity modulated according to at least two distinguishable modulation types selected from the group of modulation types comprising sinusoidal modulation, triangular wave modulation, square wave modulation, multi-pulse square wave modulation, sawtooth wave modulation, constant intensity modulation, and combinations thereof. In an embodiment, in at least one of the modulation modes, the modulation parameters are set to create the appearance to the human observer of intensity modulated by a signal having a given period. In an embodiment, at least one of the designated airfield marker types has a modulation mode with a period that is a multiple of the period of the modulation mode of another designated airfield marker type. In an embodiment, the lighting fixture controller synchronizes the start time of the period to an external synchronization signal. In an embodiment, the modulation parameters specify a delay time with respect to the external synchronization signal. In an embodiment, the period is adjustable for a modulation type to create different modulation modes. In an embodiment, in at least one of the modulation modes the modulation parameters are set to create the appearance to the human observer of a pulsed covert lighting source. In an embodiment, the modulation parameters allow the duty cycle of the pulses to be varied. In an embodiment, the modulation parameters allow the number of pulses per period to be varied. In an embodiment, the modulation parameters allow the location of each pulse within the period to be varied. In an embodiment, the modulation parameters allow the modulation depth of each pulse to be varied. In an embodiment, the modulation parameters allow the intensity of each pulse to be varied. In an embodiment, the modulation signal is an on-off signal to the covert lighting driver, and wherein the appearance of different covert lighting modulation modes is achieved by varying the on-off timing of the on-off signal. In an embodiment, the modulation signal comprises an on-off pulse train with a fundamental switching frequency of less than 60 Hz, wherein on pulses and off pulses are sequenced at the fundamental frequency to create the appearance to the human observer of apparent intensity modulation at a lower frequency. In an embodiment, the airfield lighting fixture approximates different lighting intensities by varying the duty cycle of the on pulses in the on-off pulse train. In an embodiment, the airfield lighting fixture has the ability to respond to a pilot-generated signal to approximate a different intensity. In an embodiment, the airfield lighting fixture has the ability to respond to an air traffic controller-generated signal to approximate a different intensity. In an embodiment, the lighting fixture controller comprises a receiver to receive remote mode-setting instructions. In an embodiment, the receiver couples to a signal connection, separate from a power connection, to receive the instructions. In an embodiment, the receiver couples to a power wire for the fixture to receive the instructions. In an embodiment, the receiver is a radio frequency receiver that receives the instructions wirelessly. In an embodiment, the airfield lighting fixture receives instructions sent to multiple fixtures, and wherein the receiver distinguishes instructions intended for the airfield lighting fixture. In an embodiment, the instructions contain a timing reference. In an embodiment, the type of airfield marker type designated for the airfield lighting fixture is settable to at least two different marker types, depending on the operational configuration of the airfield at which the lighting fixture is deployed. In an embodiment, the controller and modulator are implemented using a common processor and memory system. In an embodiment, the controller comprises a selection module keyed to one of the selectable covert lighting modulation modes. In an embodiment, the selection module is one of a plurality of selection module types associated with corresponding covert lighting modulation modes.

A method of operating an airfield lighting fixture has been described including generating a modulation signal, the modulation signal corresponding to one of a plurality of selectable covert lighting modulation modes, and driving a covert light source in response to the modulation signal. In an embodiment, driving a covert light source comprises supplying the modulation signal to a control terminal of a driver, the driver controlling current flow to the covert light source in response to the modulation signal. In an embodiment, the covert light source comprises at least one infrared light-emitting diode. In an embodiment, each covert lighting modulation mode relates to one or more modulation parameters that affect the modulation signal to create the appearance to a human observer, viewing the fixture through a suitable viewing apparatus, of a designated airfield marker type. In an embodiment, the modulation parameters are adjustable to create the appearance to the human observer of intensity modulated according to at least two distinguishable modulation types selected from the group of modulation types comprising sinusoidal modulation, triangular wave modulation, square wave modulation, multi-pulse square wave modulation, sawtooth wave modulation, constant intensity modulation, and combinations thereof. In an embodiment, in at least one of the modulation modes, the modulation parameters are set to create the appearance to the human observer of intensity modulated by a signal having a given period. In an embodiment, at least one of the designated airfield marker types has a modulation mode with a period that is a multiple of the period of the modulation mode of another designated airfield marker type. In an embodiment, wherein the method further includes synchronizing the start time of the period to an external synchronization signal. In an embodiment, the modulation parameters specify a delay time with respect to the external synchronization signal. In an embodiment, the period is adjustable for a modulation type to create different modulation modes. In an embodiment, in at least one of the modulation modes the modulation parameters are set to create the appearance to the human observer of a pulsed covert lighting source. In an embodiment, the modulation parameters allow the duty cycle of the pulses to be varied. In an embodiment, the modulation parameters allow the number of pulses per period to be varied. In an embodiment, the modulation parameters allow the location of each pulse within the period to be varied. In an embodiment, the modulation parameters allow the modulation depth of each pulse to be varied. In an embodiment, the modulation parameters allow the intensity of each pulse to be varied. In an embodiment, the modulation signal is an on-off signal to a covert lighting driver, and wherein the appearance of different covert lighting modulation modes is achieved by varying the on-off timing of the on-off signal. In an embodiment, the modulation signal comprises an on-off pulse train with a fundamental switching frequency of less than 60 Hz, wherein on pulses and off pulses are sequenced at the fundamental frequency to create the appearance to the human observer of apparent intensity modulation at a lower frequency. In an embodiment, the airfield lighting fixture approximates different lighting intensities by varying the duty cycle of the on pulses in the on-off pulse train. In an embodiment, the airfield lighting fixture has the ability to respond to a pilot-generated signal to approximate a different intensity. In an embodiment, the airfield lighting fixture has the ability to respond to an air traffic controller-generated signal to approximate a different intensity. In an embodiment, the method further comprises receiving remote mode-setting instructions, and using the instructions to generate the modulation signal. In an embodiment, the method further comprises receiving the remote mode-setting instructions over a signal connection separate from a power connection. In an embodiment, the method further comprises receiving the remote mode-setting instructions over a power wire. In an embodiment, the method further comprises receiving the remote mode-setting instructions wirelessly. In an embodiment, the method further comprises receiving instructions sent to multiple fixtures, and distinguishing instructions intended for the airfield lighting fixture. In an embodiment, the instructions contain a timing reference. In an embodiment, the type of airfield marker type designated for the airfield lighting fixture is settable to at least two different marker types, depending on the operational configuration of the airfield at which the lighting fixture is deployed. In an embodiment, the modulation signal is generated using a processor and memory system. In an embodiment, the method further comprises selecting one of the covert lighting modes using a selection module keyed to one of the selectable covert lighting modulation modes. In an embodiment, the selection module is one of a plurality of selection module types associated with corresponding covert lighting modulation modes.

An airfield lighting system has been described that includes a set of airfield lighting fixtures, each operable in at least one covert lighting modulation mode, wherein the airfield lighting fixtures are each set to operate in a covert lighting modulation mode according to their placement on an airfield, such that each fixture is identifiable as a designated airfield marker type. In an embodiment, the system further comprises a modulator to generate a modulation signal, the modulation signal corresponding to the covert lighting modulation mode for the airfield marker type designated for that fixture, a covert lighting driver operable in response to the modulation signal, and a covert light source controlled by the covert lighting driver. In an embodiment, the covert light source in each lighting fixture comprises at least one infrared light-emitting diode. In an embodiment, at least one of the covert lighting modulation modes relates to one or more modulation parameters that affect a modulation signal in each airfield lighting fixture operating according to that modulation mode to create the appearance to a human observer, viewing the fixtures through a suitable viewing apparatus, of different identifiable airfield marker types according to placement on the airfield. In an embodiment, the modulation parameters are adjustable to create the appearance to the human observer of intensity modulated according to at least two distinguishable modulation types selected from the group of modulation types comprising sinusoidal modulation, triangular wave modulation, square wave modulation, multi-pulse square wave modulation, sawtooth wave modulation, constant intensity modulation, and combinations thereof. In an embodiment, in at least one of the modulation modes, the modulation parameters are set to create the appearance to the human observer of intensity modulated by a signal having a given period. In an embodiment, at least one of the designated airfield marker types has a modulation mode with a period that is a multiple of the period of the modulation mode of another designated airfield marker type. In an embodiment, at least one of the airfield lighting fixtures comprising a lighting fixture controller that synchronizes the start time of the period to an external synchronization signal. In an embodiment, for the at least one of the airfield lighting fixtures the modulation parameters specify a delay time with respect to the external synchronization signal. In an embodiment, for at least one of the airfield lighting fixtures the period is adjustable for a modulation type to create different modulation modes. In an embodiment, in at least one of the modulation modes the modulation parameters are set to create the appearance to the human observer of a pulsed covert lighting source. In an embodiment, for at least one of the airfield lighting fixtures the modulation parameters allow the duty cycle of the pulses to be varied. In an embodiment, for at least one of the airfield lighting fixtures the modulation parameters allow the number of pulses per period to be varied. In an embodiment, for at least one of the airfield lighting fixtures the modulation parameters allow the location of each pulse within the period to be varied. In an embodiment, for at least one of the airfield lighting fixtures the modulation parameters allow the modulation depth of each pulse to be varied. In an embodiment, for at least one of the airfield lighting fixtures the modulation parameters allow the intensity of each pulse to be varied. In an embodiment, for at least one of the airfield lighting fixtures the modulation signal is an on-off signal to a covert lighting driver, and wherein the appearance of different covert lighting modulation modes is achieved by varying the on-off timing of the on-off signal. In an embodiment, the on-off modulation signal comprises an on-off pulse train with a fundamental switching frequency of less than 60 Hz, wherein on pulses and off pulses are sequenced at the fundamental frequency to create the appearance to the human observer of apparent intensity modulation at a lower frequency. In an embodiment, the at least one airfield lighting fixture approximates different lighting intensities by varying the duty cycle of the on pulses in the on-off pulse train. In an embodiment, at least one of the airfield lighting fixtures has the ability to respond to a pilot-generated signal to approximate a different intensity. In an embodiment, at least one of the airfield lighting fixtures has the ability to respond to an air traffic controller-generated signal to approximate a different intensity. In an embodiment, each of the airfield lighting fixtures comprises a receiver to receive remote mode-setting instructions. In an embodiment, the receiver in each airfield lighting fixture couples to a signal connection separate from a power connection to receive the instructions. In an embodiment, the receiver in each airfield lighting fixture couples to a power wire for the fixture to receive the instructions. In an embodiment, the receiver in each airfield lighting fixture is a radio frequency receiver that receives the instructions wirelessly. In an embodiment, wherein the system further comprises a lighting system controller to send mode-setting instructions to the airfield lighting fixtures. In an embodiment, at least some of the airfield lighting fixtures receive instructions sent by the lighting system controller to multiple fixtures, and wherein each such receiver distinguishes instructions intended for that airfield lighting fixture. In an embodiment, the instructions sent by the lighting system controller contain a timing reference. In an embodiment, the type of airfield marker type designated for at least some of the airfield lighting fixtures is settable by the lighting system controller to at least two different marker types, depending on the operational configuration of the airfield at which the lighting fixture is deployed. In an embodiment, at least one of the airfield lighting fixtures comprises a processor and memory system to generate a modulation signal to operate the fixture in a covert lighting modulation mode. In an embodiment, at least one of the airfield lighting fixtures comprises a selection module keyed to one of the covert lighting modulation modes to set the covert lighting modulation mode for that fixture. In an embodiment, the selection module is one of a plurality of selection module types associated with corresponding covert lighting modulation modes.

An airfield lighting fixture has been described that includes means for selecting a covert lighting modulation mode, means for generating a modulation signal corresponding to the covert lighting modulation mode, and means for driving a covert lighting source in response to the modulation signal.

An airfield lighting fixture has been described that includes at least one infrared light-emitting diode, a modulator to generate a modulation signal, the modulation signal corresponding to one of a plurality of selectable covert lighting modulation modes, a lighting fixture controller to select one of the covert lighting modulation modes for the modulator, and a covert lighting driver operable in response to the modulation signal to control the at least one infrared light-emitting diode.

It is understood that other variations may be made in the foregoing without departing from the scope of the disclosure. In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, those skilled in the art will readily appreciate that many other modifications, changes and/or substitutions are possible in the exemplary embodiments without materially departing from the novel teachings and advantages of the present disclosure. Accordingly, all such modifications, changes and/or substitutions are intended to be included within the scope of this disclosure as defined in the following claims. In the claims, means-plus-function clauses are intended to cover the structures described herein as performing the recited function and not only structural equivalents, but also equivalent structures.

What is claimed is:

1. An airfield lighting system comprising:
a modulator to generate a modulation signal, the modulation signal corresponding to one of a plurality of selectable covert lighting modulation modes;
a lighting fixture controller to select one of the covert lighting modulation modes for the modulator; and
a covert lighting driver operable in response to the modulation signal.

2. The airfield lighting fixture of claim 1, further comprising a covert light source controlled by the covert lighting driver.

3. The airfield lighting fixture of claim 2, wherein the covert light source comprises at least one infrared light-emitting diode.

4. The airfield lighting fixture of claim 1, wherein each covert lighting modulation mode relates to one or more modulation parameters that affect the modulation signal to create the appearance to a human observer, viewing the fixture through a suitable viewing apparatus, of a designated airfield marker type.

5. The airfield lighting fixture of claim 4, wherein the modulation parameters are adjustable to create the appearance to the human observer of intensity modulated according to at least two distinguishable modulation types selected from the group of modulation types comprising sinusoidal modulation, triangular wave modulation, square wave modulation, multi-pulse square wave modulation, sawtooth wave modulation, constant intensity modulation, and combinations thereof.

6. The airfield lighting fixture of claim 4, wherein in at least one of the modulation modes, the modulation parameters are set to create the appearance to the human observer of intensity modulated by a signal having a given period.

7. The airfield lighting fixture of claim 6, wherein at least one of the designated airfield marker types has a modulation mode with a period that is a multiple of the period of the modulation mode of another designated airfield marker type.

8. The airfield lighting fixture of claim 6, wherein the lighting fixture controller synchronizes the start time of the period to an external synchronization signal.

9. The airfield lighting fixture of claim 8, wherein the modulation parameters specify a delay time with respect to the external synchronization signal.

10. The airfield lighting fixture of claim 6, wherein the period is adjustable for a modulation type to create different modulation modes.

11. The airfield lighting fixture of claim 6, wherein in at least one of the modulation modes the modulation parameters are set to create the appearance to the human observer of a pulsed covert lighting source.

12. The airfield lighting fixture of claim 11, wherein the modulation parameters allow the duty cycle of the pulses to be varied.

13. The airfield lighting fixture of claim 11, wherein the modulation parameters allow the number of pulses per period to be varied.

14. The airfield lighting fixture of claim 13, wherein the modulation parameters allow the location of each pulse within the period to be varied.

15. The airfield lighting fixture of claim 11, wherein the modulation parameters allow the modulation depth of each pulse to be varied.

16. The airfield lighting fixture of claim 11, wherein the modulation parameters allow the intensity of each pulse to be varied.

17. A method of operating an airfield lighting fixture, the method comprising:
generating a modulation signal, the modulation signal corresponding to one of a plurality of selectable covert lighting modulation modes; and
driving a covert light source in response to the modulation signal.

18. An airfield lighting system comprising:
a set of airfield lighting fixtures, each operable in at least one covert lighting modulation mode, wherein the airfield lighting fixtures are each set to operate in a covert lighting modulation mode according to their placement on an airfield, such that each fixture is identifiable as a designated airfield marker type.

19. An airfield lighting fixture comprising:
means for selecting a covert lighting modulation mode;
means for generating a modulation signal corresponding to the covert lighting modulation mode; and
means for driving a covert lighting source in response to the modulation signal.

20. An airfield lighting fixture comprising:
at least one infrared light-emitting diode;
a modulator to generate a modulation signal, the modulation signal corresponding to one of a plurality of selectable covert lighting modulation modes;
a lighting fixture controller to select one of the covert lighting modulation modes for the modulator; and
a covert lighting driver operable in response to the modulation signal to control the at least one infrared light-emitting diode.
